(19) United States
(12) Patent Application Publication
(10) Pub. No.: US 2026/0361448 A1
(43) Pub. Date: Nov. 12, 2026

(54) ACCURACY-BASED TRANSMISSION USING MODULATION AND CODING LAYERS

(71) Applicant: QUALCOMM Incorporated, San Diego, CA (US)

(72) Inventors: Moshe BEN-ARI, Rehovot (IL); Peer BERGER, Hod Hasharon (IL); Shay LANDIS, Hod Hasharon (IL)

(21) Appl. No.: 19/205,117

(22) Filed: May 12, 2025

(51) Int. Cl. H04L 1/00

(52) U.S. Cl. CPC H04L 1/0009

(57) ABSTRACT

Various aspects of the present disclosure generally relate to wireless communication. In some aspects, a user equipment (UE) may transmit one or more first bits associated with a first accuracy of one or more parameters using a first modulation and coding layer corresponding to one or more first bit positions in a symbol, the first modulation and coding layer associated with a first error rate. The UE may transmit one or more second bits associated with a second accuracy of the one or more parameters using a second modulation and coding layer corresponding to one or more second bit positions in the symbol, the second modulation and coding layer associated with a second error rate that is greater than the first error rate. Numerous other aspects are described.

### FIELD OF THE DISCLOSURE

Aspects of the present disclosure generally relate to wireless communication and specifically relate to techniques, apparatuses, and methods associated with accuracy-based transmission using modulation and coding layers.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, a first user equipment (UE) and a second UE may communicate directly with one another using sidelink communications (for example, without communicating by way of a network node as an intermediary). As an example, the first UE may directly transmit data, control information, or other signaling as a sidelink communication to the second UE. In various examples, the UEs may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, or vehicle-to-pedestrian (V2P) protocols), or mesh network communication protocols.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include processor circuitry and code-storing memory circuitry. The processing system may be configured to cause the UE to transmit one or more first bits associated with a first accuracy of one or more parameters using a first modulation and coding layer corresponding to one or more first bit positions in a symbol, the first modulation and coding layer associated with a first error rate. The processing system may be configured to cause the UE to transmit one or more second bits associated with a second accuracy of the one or more parameters using a second modulation and coding layer corresponding to one or more second bit positions in the symbol, the second modulation and coding layer associated with a second error rate that is greater than the first error rate.

Some aspects described herein relate to a method of wireless communication performed by a UE. The method may include transmitting one or more first bits associated with a first accuracy of one or more parameters using a first modulation and coding layer corresponding to one or more first bit positions in a symbol, the first modulation and coding layer associated with a first error rate. The method may include transmitting one or more second bits associated with a second accuracy of the one or more parameters using a second modulation and coding layer corresponding to one or more second bit positions in the symbol, the second modulation and coding layer associated with a second error rate that is greater than the first error rate.

Some aspects described herein relate to an apparatus for wireless communication. The apparatus may include means for transmitting one or more first bits associated with a first accuracy of one or more parameters using a first modulation and coding layer corresponding to one or more first bit positions in a symbol, the first modulation and coding layer associated with a first error rate. The apparatus may include means for transmitting one or more second bits associated with a second accuracy of the one or more parameters using a second modulation and coding layer corresponding to one or more second bit positions in the symbol, the second modulation and coding layer associated with a second error rate that is greater than the first error rate.

Some aspects described herein relate to a non-transitory computer-readable medium that stores a set of instructions for wireless communication by a UE. The set of instructions, when executed by one or more processors of the UE, may cause the UE to transmit one or more first bits associated with a first accuracy of one or more parameters using a first modulation and coding layer corresponding to one or more first bit positions in a symbol, the first modulation and coding layer associated with a first error rate. The set of instructions, when executed by one or more processors of the UE, may cause the UE to transmit one or more second bits associated with a second accuracy of the one or more parameters using a second modulation and coding layer corresponding to one or more second bit positions in the symbol, the second modulation and coding layer associated with a second error rate that is greater than the first error rate.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of hierarchical modulation operations performed by a transmitter.

FIG. 3 is a diagram illustrating an example associated with signaling for accuracy-based transmission using modulation and coding layers.

FIG. 4 is a diagram illustrating examples associated with cyclic redundancy checking attaching.

FIG. 5 is a diagram illustrating an example process performed, for example, at a user equipment (UE) or an apparatus of a UE.

FIG. 6 is a diagram of an example apparatus for wireless communication.

### DETAILED DESCRIPTION

Hierarchical modulation, also known as layered modulation, is a technique used to multiplex and modulate multiple data streams into a single symbol stream. Hierarchical modulation may involve overlaying base-layer symbols with enhancement-layer symbols before transmission. In some examples, a lower modulation and coding layer may be received by all users having poor channel conditions, and a higher modulation and coding layer may be received by users with good channel conditions. Thus, hierarchical modulation may allow for graceful degradation of signal quality rather than complete loss, enabling different quality of service (QoS) for users with varying reception channel conditions. For example, in digital television broadcasting, hierarchical modulation may provide a fallback signal in case of weak reception.

Cellular V2X (CV2X) is a communication technology that enables vehicles to communicate, using cellular technology over sidelink, with each other (for example, using vehicle-to-vehicle (V2V) protocols), with infrastructure (for example, using vehicle-to-infrastructure (V2I) protocols), with pedestrians (for example, using vehicle-to-pedestrian (V2P) protocols), or with networks (for example, using vehicle-to-network (V2N) protocols), among other examples. An objective of CV2X is to improve road safety, traffic efficiency, and driving experience by enabling real-time information exchange. Basic safety messages (BSMs) are CV2X messages that assist in collision avoidance, traffic signal priority, and other safety applications by providing timely alerts and updates to drivers and automated systems. BSMs broadcast parameters that indicate a vehicle state, such as position, speed, acceleration, elevation, or heading, among other examples. Many parameters of the BSMs can have high accuracy. For example, vehicle elevation may be reported with an accuracy of 10 centimeters. Additionally or alternatively, vehicle heading may be an integer within a range of 0-28,800, represented by 15 bits, with a least significant bit corresponding to an accuracy of 0.0125 degrees.

BSMs occupy significant transmission resources, such as time and frequency resources. BSMs can be approximately 200 bytes, and additional overhead introduced by different layers can increase the size of BSMs to 300-400 bytes. Moreover, BSMs may be transmitted at intervals of 100 milliseconds or fewer, such as 20 milliseconds. In congested scenarios where numerous vehicles attempt to transmit BSMs over limited bandwidth, vehicles may transmit on the same time resources, causing a degradation in reception sensitivity for distant vehicles. Additionally or alternatively, vehicles may transmit on the same time and frequency resources, resulting in transmission collisions and direct interference, thus preventing vehicles from receiving BSMs from each other. Additionally or alternatively, vehicles may implement congestion control mechanisms, such as increasing a modulation and coding scheme (MCS) order used for transmission, which in turn reduces the reliability of reception. These issues may be exacerbated by event messages, which are complementary to BSMs within the safety layer. Event messages are triggered by specific occurrences or changes in a vehicle state that are significant enough to require immediate communication, such as sudden braking, collisions, or lane changes. Event messages are transmitted upon occurrence of a triggering event (without waiting for a next BSM transmission time), which ensures that critical information is communicated without significant delay, but also contributes to congestion and leads to BSM contention for transmission resources.

As a result, BSMs (and other messages that compete for transmission resources in congested scenarios) may increase system load and, thus, decrease reliability. Although reducing a physical resource load of the messages can help to improve reliability, such reduction may degrade performance. For example, one possible approach to reducing the physical resource load of a message involves decreasing a quantity of bits in one or more fields of the message, such as by lowering one or more accuracies of the one or more fields. For example, reducing the accuracy of a vehicle heading parameter of a BSM from 0.0125 degrees to 0.2 degrees may conserve 4 bits; however, such fixed accuracy lowering may degrade performance at the application level. Another possible approach involves increasing the MCS order, which may increase a constellation density (for example, a quadrature amplitude modulation (QAM) constellation density) or coding rate; however, such an MCS order increase may increase an error probability rate of the message, and, thus, degrade performance of message reception.

Various aspects relate generally to improving a reliability of communications, such as BSMs, using hierarchical modulation. Some aspects more specifically relate to mapping different information bits to respective modulation and coding layers of a hierarchical modulation scheme. For example, low-precision bits (“base bits”) of a parameter may be assigned to a first modulation and coding layer that has a low error rate, and high-precision bits (“accuracy bits”) of the parameter may be assigned to a second modulation and coding layer that has a higher error rate than the low error rate. In some aspects, the parameter may indicate a vehicle state (for example, the parameter may be carried in a BSM). In some examples, a receiver may receive the base bits and the accuracy bits with different error rates. In good channel conditions, the receiver may successfully decode the accuracy bits. In degraded channel conditions, the receiver may be unable to successfully decode the accuracy bits; however, because the base bits are transmitted using modulation and coding layers having lower error rates than the accuracy bits have, the receiver may successfully decode the base bits with high reliability even in degraded channel conditions. Thus, the precision with which the receiver identifies the parameter may depend on channel conditions.

In some aspects, a transmitter may attach cyclic redundancy check (CRC) bits for the accuracy bits. For example, the transmitter may wrap the accuracy bits together with the CRC bits and map the accuracy bits and CRC bits to higher modulation and coding layers (e.g., modulation and coding layers having higher error rates). The receiver may use the CRC bits to identify whether or not the accuracy bits have been decoded successfully.

In some aspects, the transmitter may refrain from attaching CRC bits for the accuracy bits. For example, the transmitter may refrain from wrapping the accuracy bits with any CRC bits. Instead, the transmitter may map the accuracy bits directly to the higher modulation and coding layers.

In some aspects, the transmitter may attach a limited quantity of CRC bits for one or more of the base bits or the accuracy bits. For example, the limited quantity may allow the receiver to use the CRC bits to identify whether or not the base or accuracy bits have been successfully decoded. Due to the quantity of CRC bits being limited, the receiver may falsely identify that the accuracy bits have been decoded successfully.

Particular aspects of the subject matter described in this disclosure can be implemented to realize one or more of the following potential advantages. In some examples, the described techniques can be used to reduce a quantity of transmission resources for transmitting an indication of a parameter without increasing an error rate for the base bits. As a result, the physical resource load of the parameters may be decreased, thereby reducing system load and, thus, increasing reliability. In some examples, the total effective code rate may increase because fewer transmission resources are used to transmit the parameter without impacting the error rate of the base bits. Thus, system effectiveness and performance may improve without degrading the functionality of the application layer. In good channel conditions, the receiver may decode the accuracy bits in addition to the base bits, thereby further improving the performance of the application layer.

Attaching CRC bits for the accuracy bits may enable the receiver to identify whether or not the accuracy bits have been decoded correctly with high probability, which may help to further improve performance. For example, the receiver may request a retransmission of the accuracy bits, or notify the application layer that the parameter is not known to a high accuracy, among other examples.

Refraining from attaching CRC bits for the accuracy bits may help to lower a code rate for a given amount of transmission resources, or decrease the quantity of transmission resources with a given code rate, compared to both the base bits and the accuracy bits having CRC bits. Because attaching incorrectly decoded accuracy bits to the base bits may not affect the accuracy of the parameters with respect to the base bits, the accuracy bits not having CRC bits may not cause degradation that impacts the base bits.

Attaching the limited quantity of CRC bits for one or more of the base or accuracy bits may enable controlling one or more CRC false pass rates so as to identify false detections (for example, with an error probability) without increasing overhead by transmitting additional CRC bits.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, CV2X communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

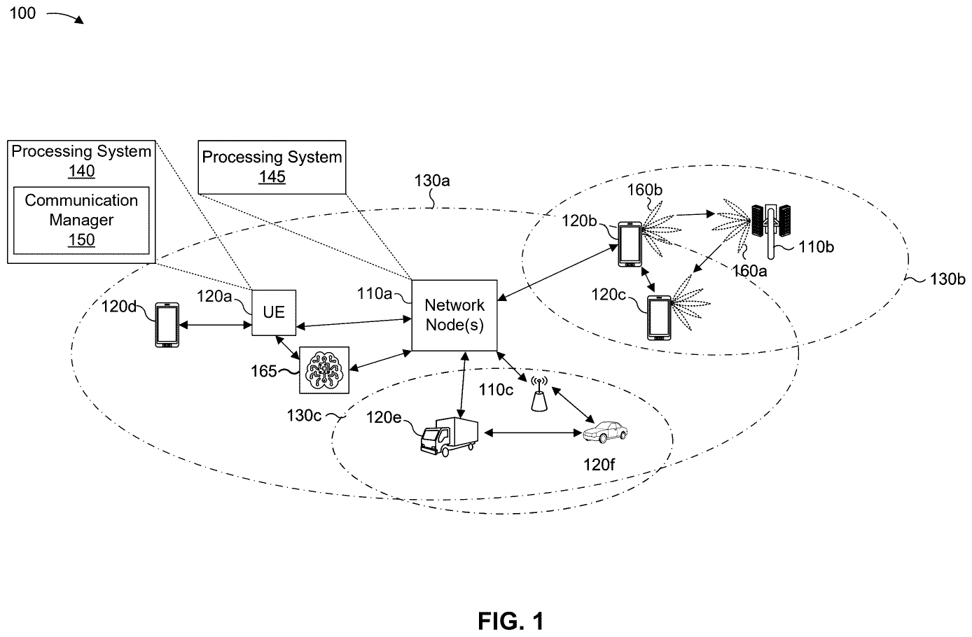

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a, a network node 110b, and a network node 110c (each of which also may be referred to herein simply as a “network node 110”). The network nodes 110 may support communications with at least one user equipment (UE) 120. For example, in FIG. 1, the network nodes 110 support communication with a UE 120a, a UE 120b, a UE 120c, a UE 120d, a UE 120e, and a UE 120f (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of QAM, such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some examples, two or more UEs 120 (for example, shown as UE 120a and UE 120d or the UE 120e and the UE 120f) may communicate directly with one another using sidelink communications (for example, without communicating by way of a network node 110 as an intermediary). As an example, the UE 120a may directly transmit data, control information, or other signaling as a sidelink communication to the UE 120d. This is in contrast to, for example, the UE 120a first transmitting data in an uplink communication to a network node 110, which then transmits the data to the UE 120d in a downlink communication. In some deployments and configurations, a network node 110 may schedule or allocate resources for sidelink communications between UEs 120 in the wireless communication network 100. For example, the cell 130c may include a V2X network supported by the network node 110c. In some examples, the network node 110c may be a roadside unit or other device deployed in the V2X network. In some other deployments and configurations, a UE 120 (instead of a network node 110) may perform, or collaborate or negotiate with one or more other UEs to perform, scheduling operations, resource selection operations, or other operations for sidelink communications. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), or a physical sidelink feedback channel (PSFCH).

In some aspects, the UE 120 may include a communication manager 150. As described in more detail elsewhere herein, the communication manager 150 may transmit one or more first bits associated with a first accuracy of one or more parameters using a first modulation and coding layer corresponding to one or more first bit positions in a symbol, the first modulation and coding layer associated with a first error rate; and transmit one or more second bits associated with a second accuracy of the one or more parameters using a second modulation and coding layer corresponding to one or more second bit positions in the symbol, the second modulation and coding layer associated with a second error rate that is greater than the first error rate. Additionally, or alternatively, the communication manager 150 may perform one or more other operations described herein.

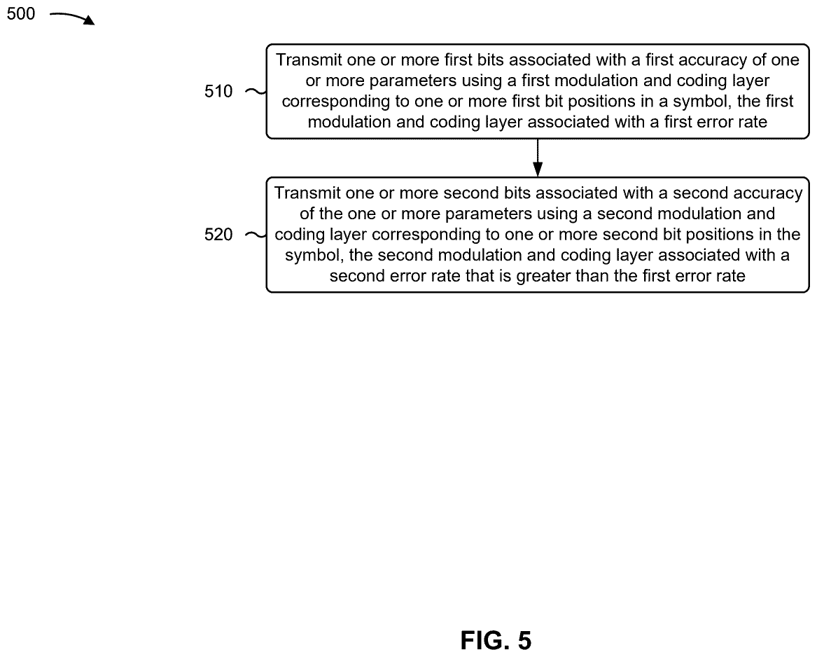

The network node 110, the processing system 145 of the network node 110, the UE 120, the processing system 140 of the UE 120, or any other component(s) of FIG. 1 may implement one or more techniques or perform one or more operations associated with accuracy-based transmission using modulation and coding layers, as described in more detail elsewhere herein. For example, the processing system 145 of the network node 110, or the processing system 140 of the UE 120 may perform or direct operations of, for example, process 500 of FIG. 5 or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 500 of FIG. 5 or other processes as described herein. In some examples, executing instructions may include running the instructions, converting the instructions, compiling the instructions, or interpreting the instructions, among other examples.

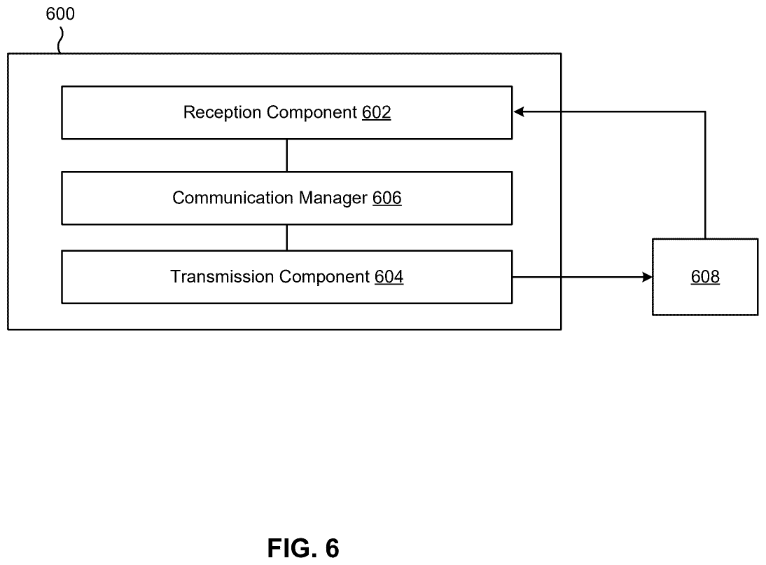

In some aspects, the UE 120 includes means for transmitting one or more first bits associated with a first accuracy of one or more parameters using a first modulation and coding layer corresponding to one or more first bit positions in a symbol, the first modulation and coding layer associated with a first error rate; or means for transmitting one or more second bits associated with a second accuracy of the one or more parameters using a second modulation and coding layer corresponding to one or more second bit positions in the symbol, the second modulation and coding layer associated with a second error rate that is greater than the first error rate. The means for the UE 120 to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

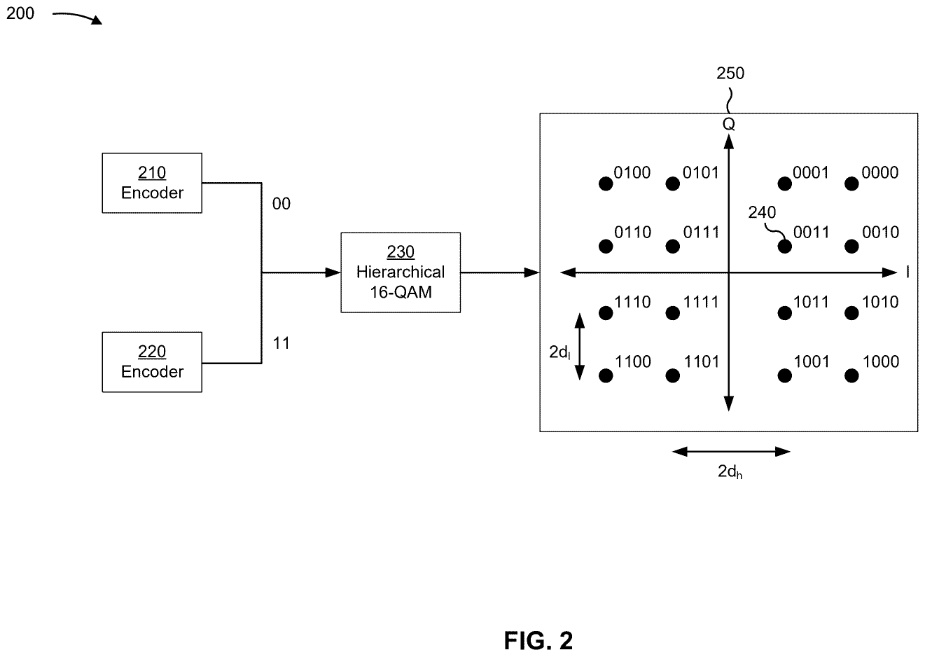

FIG. 2 is a diagram illustrating an example of hierarchical modulation operations performed by a transmitter.

Example 200 includes an encoder 210 and an encoder 220. The encoder 210 may be responsible for encoding high-priority data, and the encoder 220 may be responsible for encoding low-priority data. In example 200, the encoder 210 may encode data as high-priority bits “00”, and the encoder 220 encode data as low-priority bits “11”. A hierarchical 16-QAM block 230 may map the high-priority bits “00” to a first modulation and coding layer, and map the low-priority bits “11” to a second modulation and coding layer. The modulation and coding layers may correspond to different bit positions in a symbol 240 “0011” of a constellation 250 in an in-phase and quadrature (IQ) plane. The constellation 250 may include multiple constellation points (corresponding to symbols) that are associated with respective bit values. For example, each constellation point may be associated with multiple bits per constellation point, with the quantity of bits is based at least in part on a modulation order. In some examples, the high-priority bits “00” may be positioned in the first two bit positions of the symbol 240, and the low-priority bits “11” may be positioned in the last two bits of the symbol 240.

The first modulation and coding layer may have a lower error rate than that of the second modulation and coding layer. For example, a receiver may decode the high-priority bits “00” based at least in part on the symbol 240 being located in an upper-right quadrant of the constellation 250 because all constellation points in the upper-right quadrant begin with “00.” The receiver may decode the low-priority bits “11” based at least in part on the symbol 240 being located in a lower-left portion of the upper-right quadrant of the constellation 250. Thus, the receiver need not necessarily identify a position of the symbol 240 in the IQ plane to decode the high-priority bits “00” as precisely as the receiver would need to identify the position of the symbol 240 in the IQ plane to decode the low-priority bits “11.” In some examples, non-uniform distances dₗ and dₕ of the IQ plane may set a degree of freedom that controls interference and an energy ratio between the first and second modulation and coding layers.

As noted above, BSMs (and other messages that compete for transmission resources in congested scenarios) may increase system load and, thus, decrease reliability. Although reducing a physical resource load of the messages can help to improve reliability, such reduction may degrade performance. For example, one possible approach to reducing the physical resource load of a message involves decreasing a quantity of bits in one or more fields of the message, such as by lowering one or more accuracies of the one or more fields. For example, reducing the accuracy of a vehicle heading parameter of a BSM from 0.0125 degrees to 0.2 degrees may conserve 4 bits; however, such fixed accuracy lowering may degrade performance at the application level. Another possible approach involves increasing the MCS order, which may increase a constellation density (for example, a QAM constellation density) or coding rate; however, such an MCS order increase may increase an error probability rate of the message, and, thus, degrade performance of message reception. Some techniques described herein may help to improve a reliability of communications, such as BSMs, using hierarchical modulation.

As indicated above, FIG. 2 is provided as an example. Other examples may differ from what is described with respect to FIG. 2.

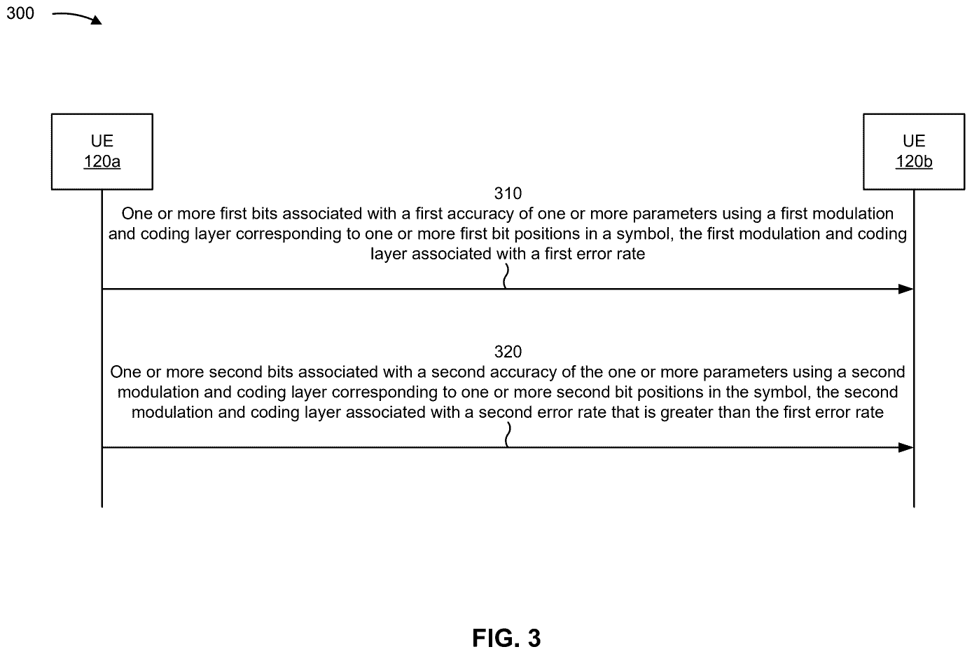

FIG. 3 is a diagram illustrating an example 300 associated with signaling for accuracy-based transmission modulation and coding layers. As shown in FIG. 3, a UE 120a and a UE 120b may communicate with one another via a sidelink. Other examples may involve communications via other types of links (e.g., via links having fixed message content that may be split between higher-accuracy bits and lower-accuracy bits) in accordance with examples provided herein. For example, a UE 120 and a network node 110 may communicate with one another via an uplink or a downlink in accordance with examples provided herein.

In a first operation 310, the UE 120a may transmit, and the UE 120b may receive, one or more first bits associated with a first accuracy of one or more parameters. The one or more parameters may convey a numerical value using one or more bits. The one or more first bits may be associated with the first accuracy of the one or more parameters in that the one or more first bits may indicate a value of the one or more parameters up to the first accuracy. For example, if a parameter relates to a distance, then the one or more first bits may indicate a value of the parameter at a precision of meters (where the first accuracy is meters). In some aspects, the one or more first bits may be one or more most significant bits (MSBs) of the one or more parameters. For example, the one or more first bits may hold a highest value position of the one or more parameters. For example, the one or more first bits may represent one or more largest portions of one or more total values of the one or more parameters.

In some aspects, the one or more parameters may be one or more BSM parameters. A BSM parameter may be a numerical parameter conveyed in a BSM. For example, the BSM parameter may convey information relating to a vehicle state. In some aspects, the one or more BSM parameters may include one or more of: a latitude parameter, a longitude parameter, an elevation parameter, a positional accuracy parameter, a speed parameter, a heading parameter, a steering wheel angle parameter, or an acceleration parameter. The latitude parameter may indicate a geographic latitude of a vehicle. In some examples, the latitude parameter may be an integer within the range −900000000 to 900000001 and have a least significant bit (LSB) of 0.1 microdegrees. The longitude parameter may indicate a geographic longitude of a vehicle. In some examples, the longitude parameter may be an integer within the range −1799999999 to 1800000001 and have an LSB of 0.1 microdegrees. The elevation parameter may indicate a geographic elevation of a vehicle. In some examples, the elevation parameter may be an integer within the range −4096 to 61439 and be measured in units of 10 centimeter steps. A positional accuracy parameter may indicate an accuracy to which the position of the vehicle (for example, the latitude, longitude, or elevation of the vehicle) is known. The speed parameter may indicate a speed of a vehicle. In some examples, the speed parameter may be an integer within the range 0 to 8191 and be measured in units of 0.02 meters per second. The heading parameter may indicate an orientation of a vehicle, such as a direction in which the vehicle is pointing. In some examples, the heading parameter may be an integer within the range 0 to 28800 and have an LSB of 0.0125 degrees. The steering wheel angle parameter may indicate an angle at which a steering wheel of the vehicle is turned. In some examples, the steering wheel angle parameter may be an integer within the range −126 to 127 and have an LSB of 1.5 degrees. The acceleration parameter may measure a rate of change in a velocity of the vehicle. In some examples, the acceleration parameter may indicate an acceleration of the vehicle along three directions, and a yaw rotation rate of the vehicle. An example BSM format is provided below that includes each of the parameters described above, where the acceleration parameter corresponds to “AccelerationSet4Way.”
BSMcoreData ::=Sequence {
msgCnt MsgCount,
id TemporaryID,
secMark DSecond,
lat Latitude,
long Longitude,
elev Elevation,
accuracy PositionalAccuracy,
transmission TransmissionState,
speed Speed,
heading Heading,
angle SteeringWheelAngle,
accelSet AccelerationSet4Way,
brakes BrakeSystemStatus,
size VehicleSize
}

In some aspects, the UE 120a may transmit, and the UE 120b may receive, the one or more first bits using a first modulation and coding layer corresponding to one or more first bit positions in a symbol. A modulation and coding layer may be a level within a hierarchical modulation scheme in which data having a given priority is encoded. In some examples, the one or more first bits may be positioned in one or more first bit positions in the symbol (e.g., in one or more left-most bit positions of the symbol). In some aspects, the first modulation and coding layer may be associated with a first error rate. For example, the first modulation and coding layer may be associated with the first error rate in that the first modulation and coding layer may be subject to the first error rate. For example, the UE 120b may successfully decode the one or more first bits at a rate consistent with the first error rate of the first modulation and coding layer. In some examples, the first error rate may be specific to a given set of channel conditions (e.g., the first modulation and coding layer may be associated with the first error rate for the given set of channel conditions). As discussed above in connection with FIG. 2, the first error rate may depend on the arrangement and spacing of constellation points within a constellation.

In a second operation 320, the UE 120a may transmit, and the UE 120b may receive, one or more second bits associated with a second accuracy of the one or more parameters. The one or more second bits may be associated with the second accuracy of the one or more parameters in that the one or more second bits may indicate a value of the one or more parameters up to the second accuracy. For example, if a parameter relates to a distance, then the one or more second bits may indicate a value of the parameter at a precision of centimeters (where the second accuracy is centimeters). In some examples, the second accuracy may be greater than the first accuracy. For example, in the example where a parameter relates to a distance, then the one or more first bits may indicate a value of the parameter at a precision of meters, and the one or more second bits may indicate the value of the parameter at a precision of centimeters. In some aspects, the one or more second bits may be one or more LSBs of the one or more parameters. For example, the one or more second bits may hold a lowest value position of the one or more parameters. For example, the one or more second bits may represent one or more smallest portions of one or more total values of the one or more parameters.

In some aspects, the UE 120a may transmit, and the UE 120b may receive, the one or more second bits using a second modulation and coding layer corresponding to one or more second bit positions in the symbol. For example, the one or more second bits may be positioned in one or more second bit positions in the symbol (e.g., in one or more right-most bit positions of the symbol). In some examples, the second modulation and coding layer may be associated with a second error rate. For example, the second modulation and coding layer may be associated with the second error rate in that the second modulation and coding layer may be subject to the second error rate. For example, the UE 120b may successfully decode the one or more second bits at a rate consistent with the second error rate of the second modulation and coding layer. In some examples, the second error rate may be specific to the same given set of channel conditions associated with the first error rate (e.g., the second modulation and coding layer may be associated with the second error rate for the same given set of channel conditions). As discussed above in connection with FIG. 2, the second error rate may depend on the arrangement and spacing of constellation points within a constellation.

In some aspects, the second error rate may be greater than the first error rate. For example, the one or more first bits may have lower error rates than the one or more second bits have. Thus, for example, lower-accuracy portions of the parameters (as represented by the one or more first bits) may have lower error rates than high-accuracy portions of the parameters (as represented by the one or more second bits) have. In some examples, the UE 120a may use hierarchical modulation to assign the one or more first bits to the first modulation and coding layer in accordance with the first modulation and coding layer having a low error rate, and assign the one or more second bits to the second modulation and coding layer in accordance with the second modulation and coding layer having a high error rate. For example, the one or more first bits may be mapped to the first modulation and coding layer (which may be referred to as a “lower modulation and coding layer”), and the one or more second bits may be mapped to the second modulation and coding layer (which may be referred to as a “higher modulation and coding layer”). For example, the MSB(s) (as represented by the one or more first bits) may be mapped to the lower error rate, and the LSB(s) (as represented by the one or more second bits) may be mapped to the higher error rate. In some examples, for a given channel condition, the first error rate may be less than a first error probability threshold Pr1 for specific channel conditions, and the second error rate may be less than a second error probability threshold Pr2 for the same specific channel conditions, where Pr1 is less than Pr2. In some examples, the UE 120b (for example, a modem or PHY layer of the UE 120b) may inform the application layer as to whether the accuracy of the parameters is low or high. For example, the UE 120b may inform the application layer as to whether or not the one or more second bits increase the accuracy of the one or more parameters (for example, depending on whether or not the channel conditions allow the UE 120b to decode the second bit(s)).

As indicated above, FIG. 3 is provided as an example. Other examples may differ from what is described with respect to FIG. 3.

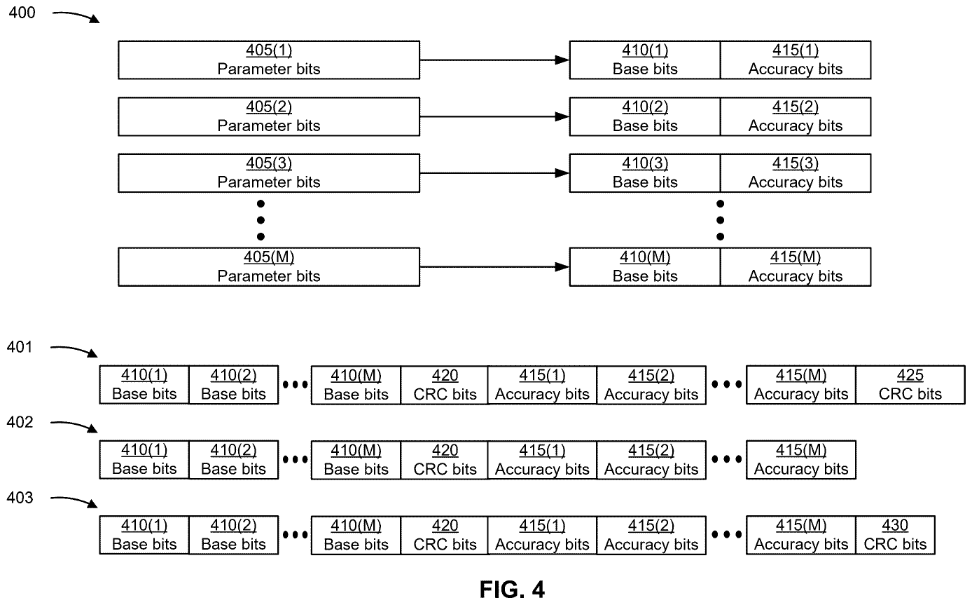

FIG. 4 is a diagram illustrating examples 400-403 associated with cyclic redundancy checking attaching.

As shown by example 400, parameter bits 405(1)-405(M) may be partitioned into base bits 410(1)-410(M) and accuracy bits 415(1)-415(M). The parameter bits 405(1)-405(M) may be bits of the one or more parameters discussed above in connection with FIG. 3. The base bits 410(1)-410(M) may be the one or more first bits discussed above in connection with FIG. 3. The accuracy bits 415(1)-415(M) may be the one or more second bits discussed above in connection with FIG. 3. In some examples, the base bits 410(1)-410(M) may be MSBs of the one or more parameters, and the accuracy bits 415(1)-415(M) may be LSBs of the one or more parameters.

In examples 401-403, the accuracy bits 415(1)-415(M) may have varying quantities of CRC bits. In example 401, the UE 120a may transmit, and the UE 120b may receive, the base bits 410(1)-410(M), one or more CRC bits 420, the accuracy bits 415(1)-415(M), and one or more CRC bits 425. In some aspects, the one or more first bits may be associated with one or more CRC bits. For example, the base bits 410(1)-410(M) may be associated with the one or more CRC bits 420. The one or more first bits may be associated with the one or more CRC bits in that the UE 120b may use the one or more CRC bits (for example, the one or more CRC bits 420) to identify whether the UE 120b successfully decoded the one or more first bits (for example, the base bits 410(1)-410(M)). For example, the UE 120a may attach one set of CRC bits (for example, the one or more CRC bits 420) for the base bits 410(1)-410(M), which may have a low error rate. Thus, the base bits 410(1)-410(M) may be wrapped together with the one or more CRC bits 420 and coded and mapped to the first modulation and coding layer. In some examples, other parameter bits (for example, bits of “MsgCount,” “TemporaryID,” “DSecond,” “TransmissionState,” “BrakeSystemStatus,” or “VehicleSize,” among other examples) may also be wrapped together with the one or more CRC bits 420 and coded and mapped to the first modulation and coding layer.

In some aspects, the one or more second bits may be associated with one or more CRC bits. For example, the accuracy bits 415(1)-415(M) may be associated with the one or more CRC bits 425. The one or more second bits may be associated with the one or more CRC bits in that the UE 120b may use the one or more CRC bits (for example, the one or more CRC bits 425) to identify whether the UE 120b successfully decoded the one or more second bits (for example, the accuracy bits 415(1)-415(M)). For example, the UE 120a may attach one set of CRC bits (for example, the one or more CRC bits 425) for the accuracy bits 415(1)-415(M), which may have a high error rate. Thus, the accuracy bits 415(1)-415(M) may be wrapped together with the one or more CRC bits 425 and coded and mapped to the second modulation and coding layer.

In example 402, the UE 120a may transmit, and the UE 120b may receive, the base bits 410(1)-410(M), one or more CRC bits 420, and the accuracy bits 415(1)-415(M). In some aspects, the one or more second bits may not be associated with any CRC bits. The one or more second bits may not be associated with any CRC bits in that the UE 120b may not use any CRC bits to identify whether the UE 120b successfully decoded the one or more second bits (for example, the accuracy bits 415(1)-415(M)). For example, the UE 120a may refrain from attaching any CRC bits for the accuracy bits 415(1)-415(M). Instead, the UE 120 may code and map the accuracy bits 415(1)-415(M) directly to the second modulation and coding layer.

In example 403, the UE 120a may transmit, and the UE 120b may receive, the base bits 410(1)-410(M), one or more CRC bits 420, the accuracy bits 415(1)-415(M), and one or more CRC bits 430. In some aspects, the accuracy bits 415(1)-415(M) may be associated with the one or more CRC bits 430 in that the UE 120b may use the one or more CRC bits 430 to identify whether the UE 120b successfully decoded the accuracy bits 415(1)-415(M). In some aspects, a quantity of the one or more CRC bits (for example, the one or more CRC bits 420 or the one or more CRC bits 430) may be associated with a CRC false detection rate. A CRC false detection rate (or “CRC false pass rate”) may be a rate at which the UE 120b falsely identifies, using the one or more CRC bits 420 or the one or more CRC bits 430, that the UE 120b successfully decoded a base bit or an accuracy bit. The quantity of the one or more CRC bits 420 or the one or more CRC bits 430 may be associated with a CRC false detection rate in that the CRC false detection rate depends on the quantity of the one or more CRC bits 420 or the one or more CRC bits 430. In some examples, the quantity of the one or more CRC bits 420 may be such that the CRC false detection rate of the base bits 410(1)-410(M) is less than a first CRC false detection threshold, and the quantity of the one or more CRC bits 430 may be such that the CRC false detection rate of the accuracy bits 415(1)-415(M) is less than a second CRC false detection threshold. In some examples, the first CRC false detection threshold and the second CRC false detection threshold may depend on the application layer. In some examples, the second CRC false detection threshold may be greater than the first CRC false detection threshold. For example, the quantity of the one or more CRC bits 430 may be less than a quantity of the one or more CRC bits 425.

As indicated above, FIG. 4 is provided as an example. Other examples may differ from what is described with respect to FIG. 4.

The second modulation and coding layer being associated with a second error rate that is greater than the first error rate may help to decrease a physical resource load of the one or more parameters, thereby decreasing system load and, thus, increasing reliability. For example, the UE 120b may decode the one or more parameters with low accuracy in both poor and good channel conditions, and may decode the one or more parameters with high accuracy in good channel conditions. In some examples, the total effective code rate may increase because fewer transmission resources are used to transmit the first and second bits without impacting the error rate of the one or more first bits (for example, the one or more first error probabilities). Thus, system effectiveness and performance may improve without degrading the functionality of the application layer. In good channel conditions, the UE 120b may decode the one or more second bits (for example, accuracy bits), thereby improving the performance of the application layer.

The one or more parameters being one or more BSM parameters may involve moving the mapping of BSMs into the PHY layer of the modem, which may avoid higher-layer encapsulation and thereby reduce overall latency. For example, techniques described herein may be performed on behalf of the BSM parameters by the PHY layer, rather than a higher layer that is associated with more latency than that of the PHY layer.

The one or more second bits being associated with one or more CRC bits may enable the modem to identify whether the second bit(s) have been decoded correctly with high probability, thereby improving performance.

The one or more second bits not being associated with one or more CRC bits may help to lower a code rate for a given amount of transmission resources, or decrease the quantity of transmission resources with a given code rate, compared to both the first and second bits being associated with CRC bits. Because attaching incorrectly decoded second bits (for example, accuracy bits) to the first bits (for example, base bits) may not affect the accuracy of the parameters with respect to the first bits (for example, the base bits), the one or more second bits not being associated with one or more CRC bits may not lead to degradation that impacts the first accuracy of the first bits.

A quantity of the one or more first CRC bits being associated with a first CRC false detection rate, and a quantity of the one or more second CRC bits being associated with a second CRC false detection rate, may enable controlling the first and second CRC false detection rates so as to allow the UE 120b to identify false detections (with an error probability) while conserving overhead.

FIG. 5 is a diagram illustrating an example process 500 performed, for example, at a UE or an apparatus of a UE. Example process 500 is an example where the apparatus or the UE (e.g., UE 120) performs operations associated with accuracy-based transmission using modulation and coding layers.

As shown in FIG. 5, in some aspects, process 500 may include transmitting one or more first bits associated with a first accuracy of one or more parameters using a first modulation and coding layer corresponding to one or more first bit positions in a symbol, the first modulation and coding layer associated with a first error rate (block 510). For example, the UE (e.g., using transmission component 604 or communication manager 606, depicted in FIG. 6) may transmit one or more first bits associated with a first accuracy of one or more parameters using a first modulation and coding layer corresponding to one or more first bit positions in a symbol, the first modulation and coding layer associated with a first error rate, as described above.

As further shown in FIG. 5, in some aspects, process 500 may include transmitting one or more second bits associated with a second accuracy of the one or more parameters using a second modulation and coding layer corresponding to one or more second bit positions in the symbol, the second modulation and coding layer associated with a second error rate that is greater than the first error rate (block 520). For example, the UE (e.g., using transmission component 604 or communication manager 606, depicted in FIG. 6) may transmit one or more second bits associated with a second accuracy of the one or more parameters using a second modulation and coding layer corresponding to one or more second bit positions in the symbol, the second modulation and coding layer associated with a second error rate that is greater than the first error rate, as described above.

Process 500 may include additional aspects, such as any single aspect or any combination of aspects described below or in connection with one or more other processes described elsewhere herein.

In a first aspect, the one or more first bits are one or more most significant bits of the one or more parameters, and wherein the one or more second bits are one or more least significant bits of the one or more parameters.

In a second aspect, alone or in combination with the first aspect, the one or more parameters are one or more BSM parameters.

In a third aspect, alone or in combination with one or more of the first and second aspects, the one or more BSM parameters include one or more of a latitude parameter, a longitude parameter, an elevation parameter, a positional accuracy parameter, a speed parameter, a heading parameter, a steering wheel angle parameter, or an acceleration parameter.

In a fourth aspect, alone or in combination with one or more of the first through third aspects, the one or more first bits are associated with one or more CRC bits.

In a fifth aspect, alone or in combination with one or more of the first through fourth aspects, the one or more second bits are associated with one or more CRC bits.

In a sixth aspect, alone or in combination with one or more of the first through fifth aspects, the one or more second bits are not associated with any CRC bits.

In a seventh aspect, alone or in combination with one or more of the first through sixth aspects, the one or more first bits are associated with one or more first CRC bits, the one or more second bits are associated with one or more second CRC bits, a quantity of the one or more first CRC bits is associated with a first CRC false detection rate, and a quantity of the one or more second CRC bits is associated with a second CRC false detection rate.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 150 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 described in connection with FIG. 1) of the UE.

In some aspects, the apparatus 600 may be configured to perform one or more operations described herein in connection with FIGS. 3-4. Additionally, or alternatively, the apparatus 600 may be configured to perform one or more processes described herein, such as process 500 of FIG. 5. In some aspects, the apparatus 600 or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The transmission component 604 may transmit one or more first bits associated with a first accuracy of one or more parameters using a first modulation and coding layer corresponding to one or more first bit positions in a symbol, the first modulation and coding layer associated with a first error rate. The transmission component 604 may transmit one or more second bits associated with a second accuracy of the one or more parameters using a second modulation and coding layer corresponding to one or more second bit positions in the symbol, the second modulation and coding layer associated with a second error rate that is greater than the first error rate.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a user equipment (UE), comprising: transmitting one or more first bits associated with a first accuracy of one or more parameters using a first modulation and coding layer corresponding to one or more first bit positions in a symbol, the first modulation and coding layer associated with a first error rate; and transmitting one or more second bits associated with a second accuracy of the one or more parameters using a second modulation and coding layer corresponding to one or more second bit positions in the symbol, the second modulation and coding layer associated with a second error rate that is greater than the first error rate.

Aspect 2: The method of Aspect 1, wherein the one or more first bits are one or more most significant bits of the one or more parameters, and wherein the one or more second bits are one or more least significant bits of the one or more parameters.

Aspect 3: The method of any of Aspects 1-2, wherein the one or more parameters are one or more basic safety message (BSM) parameters.

Aspect 4: The method of Aspect 3, wherein the one or more BSM parameters include one or more of: a latitude parameter, a longitude parameter, an elevation parameter, a positional accuracy parameter, a speed parameter, a heading parameter, a steering wheel angle parameter, or an acceleration parameter.

Aspect 5: The method of any of Aspects 1-4, wherein the one or more first bits are associated with one or more cyclic redundancy check bits.

Aspect 6: The method of any of Aspects 1-5, wherein the one or more second bits are associated with one or more cyclic redundancy check (CRC) bits.

Aspect 7: The method of any of Aspects 1-6, wherein the one or more second bits are not associated with any cyclic redundancy check bits.

Aspect 8: The method of any of Aspects 1-7, wherein the one or more first bits are associated with one or more first cyclic redundancy check (CRC) bits, the one or more second bits are associated with one or more second CRC bits, a quantity of the one or more first CRC bits is associated with a first CRC false detection rate, and a quantity of the one or more second CRC bits is associated with a second CRC false detection rate.

Aspect 9: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-8.

Aspect 10: An apparatus for wireless communication at a device, the apparatus comprising one or more memories and one or more processors coupled to the one or more memories, the one or more processors configured to cause the device to perform the method of one or more of Aspects 1-8.

Aspect 11: An apparatus for wireless communication, the apparatus comprising at least one means for performing the method of one or more of Aspects 1-8.

Aspect 12: A non-transitory computer-readable medium storing code for wireless communication, the code comprising instructions executable by one or more processors to perform the method of one or more of Aspects 1-8.

Aspect 13: A non-transitory computer-readable medium storing a set of instructions for wireless communication, the set of instructions comprising one or more instructions that, when executed by one or more processors of a device, cause the device to perform the method of one or more of Aspects 1-8.

Aspect 14: A device for wireless communication, the device comprising a processing system that includes one or more processors and one or more memories coupled with the one or more processors, the processing system configured to cause the device to perform the method of one or more of Aspects 1-8.

Aspect 15: An apparatus for wireless communication at a device, the apparatus comprising one or more memories and one or more processors coupled to the one or more memories, the one or more processors individually or collectively configured to cause the device to perform the method of one or more of Aspects 1-8.

Aspect 16: A device comprising a processing system that includes one or more processors and one or more code-storing memories coupled with the one or more processors, the processing system configured to cause the device to perform the method of one or more of Aspects 1-8.

Aspect 17: A device comprising a processing system that includes processor circuitry and code-storing memory circuitry, the processing system configured to cause the device to perform the method of one or more of Aspects 1-8.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes processor circuitry and code-storing memory circuitry, the processing system configured to cause the UE to:
transmit one or more first bits associated with a first accuracy of one or more parameters using a first modulation and coding layer corresponding to one or more first bit positions in a symbol, the first modulation and coding layer associated with a first error rate; and
transmit one or more second bits associated with a second accuracy of the one or more parameters using a second modulation and coding layer corresponding to one or more second bit positions in the symbol, the second modulation and coding layer associated with a second error rate that is greater than the first error rate.

2. The UE of claim 1, wherein the one or more first bits are one or more most significant bits of the one or more parameters, and wherein the one or more second bits are one or more least significant bits of the one or more parameters.

3. The UE of claim 1, wherein the one or more parameters are one or more basic safety message (BSM) parameters.

4. The UE of claim 3, wherein the one or more BSM parameters include one or more of: a latitude parameter, a longitude parameter, an elevation parameter, a positional accuracy parameter, a speed parameter, a heading parameter, a steering wheel angle parameter, or an acceleration parameter.

5. The UE of claim 1, wherein the one or more first bits are associated with one or more cyclic redundancy check bits.

6. The UE of claim 1, wherein the one or more second bits are associated with one or more cyclic redundancy check (CRC) bits.

7. The UE of claim 1, wherein the one or more second bits are not associated with any cyclic redundancy check bits.

8. The UE of claim 1, wherein the one or more first bits are associated with one or more first cyclic redundancy check (CRC) bits, the one or more second bits are associated with one or more second CRC bits, a quantity of the one or more first CRC bits is associated with a first CRC false detection rate, and a quantity of the one or more second CRC bits is associated with a second CRC false detection rate.

9. A method of wireless communication performed by a user equipment (UE), comprising:
transmitting one or more first bits associated with a first accuracy of one or more parameters using a first modulation and coding layer corresponding to one or more first bit positions in a symbol, the first modulation and coding layer associated with a first error rate; and
transmitting one or more second bits associated with a second accuracy of the one or more parameters using a second modulation and coding layer corresponding to one or more second bit positions in the symbol, the second modulation and coding layer associated with a second error rate that is greater than the first error rate.

10. The method of claim 9, wherein the one or more first bits are one or more most significant bits of the one or more parameters, and wherein the one or more second bits are one or more least significant bits of the one or more parameters.

11. The method of claim 9, wherein the one or more parameters are one or more basic safety message (BSM) parameters.

12. The method of claim 11, wherein the one or more BSM parameters include one or more of: a latitude parameter, a longitude parameter, an elevation parameter, a positional accuracy parameter, a speed parameter, a heading parameter, a steering wheel angle parameter, or an acceleration parameter.

13. The method of claim 9, wherein the one or more first bits are associated with one or more cyclic redundancy check bits.

14. The method of claim 9, wherein the one or more second bits are associated with one or more cyclic redundancy check (CRC) bits.

15. The method of claim 9, wherein the one or more second bits are not associated with any cyclic redundancy check bits.

16. The method of claim 9, wherein the one or more first bits are associated with one or more first cyclic redundancy check (CRC) bits, the one or more second bits are associated with one or more second CRC bits, a quantity of the one or more first CRC bits is associated with a first CRC false detection rate, and a quantity of the one or more second CRC bits is associated with a second CRC false detection rate.

17. An apparatus for wireless communication, comprising:
means for transmitting one or more first bits associated with a first accuracy of one or more parameters using a first modulation and coding layer corresponding to one or more first bit positions in a symbol, the first modulation and coding layer associated with a first error rate; and
means for transmitting one or more second bits associated with a second accuracy of the one or more parameters using a second modulation and coding layer corresponding to one or more second bit positions in the symbol, the second modulation and coding layer associated with a second error rate that is greater than the first error rate.

18. The apparatus of claim 17, wherein the one or more first bits are one or more most significant bits of the one or more parameters, and wherein the one or more second bits are one or more least significant bits of the one or more parameters.

19. The apparatus of claim 17, wherein the one or more parameters are one or more basic safety message (BSM) parameters.

20. The apparatus of claim 19, wherein the one or more BSM parameters include one or more of: a latitude parameter, a longitude parameter, an elevation parameter, a positional accuracy parameter, a speed parameter, a heading parameter, a steering wheel angle parameter, or an acceleration parameter.
